(19) United States
(12) Patent Application Publication
(10) Pub. No.: US 2020/0389354 A1
(43) Pub. Date: Dec. 10, 2020

(54) Network Accessing Method, Apparatus for a Voice Device, and Storage Medium

(71) Applicant: Baidu Online Network Technology (Beijing) Co., Ltd, Beijing (CN)

(72) Inventors: Hongwei CAO, Beijing (CN); Kaihua ZHU, Beijing (CN)

(73) Assignee: Baidu Online Network Technology (Beijing) Co., Ltd, Beijing (CN)

(21) Appl. No.: 16/690,359

(22) Filed: Nov. 21, 2019

(30) Foreign Application Priority Data
Jun. 6, 2019 (CN) 201910496023.9

(51) Int. Cl. H04L 12/24; G10L 13/047; G10L 13/04; G10L 17/24; H04L 29/06

(52) U.S. Cl. CPC H04L 41/0806; G10L 13/047; H04L 63/0861; G10L 17/24; H04L 63/083; G10L 13/043

(57) ABSTRACT

A network accessing method, apparatus for a voice device, and a computer-readable storage medium are provided. The network accessing method for a voice device includes: receiving voice broadcast information; detecting network accessing information in the voice broadcast information, wherein the network accessing information includes a name and a password of a network; analyzing the voice broadcast information to obtain the network accessing information; and instructing the voice device to access the network according to the network accessing information.

### CROSS-REFERENCE TO RELATED APPLICATION

This application claims priority to Chinese patent application No. 201910496023.9, filed on Jun. 6, 2019, which is hereby incorporated by reference in its entirety.

### TECHNICAL FIELD

The present application relates to a field of information technology, and in particular, to a network accessing method, apparatus for a voice device, and a computer-readable storage medium.

### BACKGROUNDS

A smart voice device, such as a smart speaker, may be enabled to access an Internet via a configured wireless fidelity (Wi-Fi) network. However, the process of enabling a smart voice device to access a network is relatively complicated, the operation is cumbersome, and the user experience is poor. For example, a user purchases a smart voice device and wants to download a companion application (APP) to the device and then use it. In this case, information such as the service set identifier (SSID) and the password of the local Wi-Fi needs to be sent to the smart voice device by means of a Bluetooth or a smart configuration, aka fast connection (smartconfig) communication mechanism. After receiving correct SSID and password, the smart voice device may then connect to the Wi-Fi, so as to access content or services on the Internet. The above-mentioned network accessing process is relatively complicated, and user experience is poor.

Specifically, the current network accessing method for a voice device has following drawbacks.

1) A companion APP is required to be downloaded, which increases user costs.

2) In the case where a smartconfig is used for communication, a user needs to set the smart voice device in a promiscuous mode first, then input a SSID and a password in the companion APP to communicate with the smart voice device through a user datagram protocol (UDP). After receiving the SSID and the password, the smart voice device needs to be switched out of the promiscuous mode, so as to enable to access a network. Once an error is found, the smart voice device needs to be switched back to promiscuous mode again, so that a user may input again. Therefore, the overall time period of the network accessing process is relatively long.

3) In the 5 GHz band, there is a certain chance that a network access may fail via a smartconfig.

4) If a Bluetooth is used for accessing a network, a Bluetooth module needs to be added into the smart voice device, which increases the hardware and software cost of the smart voice device.

### SUMMARY

A network accessing method, apparatus for a voice device, and a computer-readable storage medium are provided according to embodiments of the present application, so as to at least solve the above technical problems in the existing technology.

In a first aspect, a network accessing method for a voice device is provided according to an embodiment of the present application. The method includes:

receiving voice broadcast information;

detecting network accessing information in the voice broadcast information, wherein the network accessing information includes a name and a password of a network;

analyzing the voice broadcast information to obtain the network accessing information;

and instructing the voice device to access the network according to the network accessing information.

In an implementation, before the receiving voice broadcast information, the method further includes:

activating the voice device; and

monitoring the voice broadcast information.

In an implementation, the method further includes:

broadcasting an accessing result, wherein the accessing result includes a successful accessing and a failed accessing.

In a second aspect, a network accessing method for a voice device is provided according to an embodiment of the present application. The method includes:

receiving network accessing information input by a user, wherein the network accessing information includes a name and a password of a network;

sending the network accessing information to a server;

receiving voice broadcast information from the server, wherein the voice broadcast information is generated by the server according to the network accessing information; and

broadcasting a voice according to the voice broadcast information.

In a third aspect, a network accessing method for a voice device is provided according to an embodiment of the present application. The method includes:

receiving network accessing information from a user terminal, wherein the network accessing information includes a name and a password of a network;

generating voice broadcast information according to the network accessing information;

and sending the voice broadcast information to the user terminal.

In a fourth aspect, a network accessing apparatus for a voice device is provided according to an embodiment of the present application. The apparatus includes:

a first receiving unit, configured to receive voice broadcast information;

a detection unit, configured to detect network accessing information in the voice broadcast information, wherein the network accessing information includes a name and a password of a network;

a parsing unit, configured to analyze the voice broadcast information to obtain the network accessing information; and

a network accessing unit, configured to instruct the voice device to access the network according to the network accessing information.

In an implementation, the first receiving unit is configured to:

activate the voice device; and

monitor the voice broadcast information.

In an implementation, the apparatus further includes a first broadcasting unit, configured to:

broadcast an accessing result, wherein the accessing result includes a successful accessing and a failed accessing.

In a fifth aspect, a network accessing apparatus for a voice device is provided according to an embodiment of the present application. The apparatus includes:

a second receiving unit, configured to receive network accessing information input by a user, wherein the network accessing information includes a name and a password of a network;

a first sending unit, configured to send the network accessing information to a server;

a third receiving unit, configured to receive voice broadcast information from the server, wherein the voice broadcast information is generated by the server according to the network accessing information; and

a second broadcasting unit, configured to broadcast voice according to the voice broadcast information.

In a sixth aspect, a network accessing apparatus for a voice device is provided according to an embodiment of the present application. The apparatus includes:

a fourth receiving unit, configured to receive network accessing information from a user terminal, wherein the network accessing information includes a name and a password of a network;

an information generation unit, configured to generate voice broadcast information according to the network accessing information; and

a second sending unit, configured to send the voice broadcast information to the user terminal.

In a seventh aspect, a network accessing apparatus for a voice device is provided according to an embodiment of the present application. The functions of the apparatus may be implemented by using hardware or by corresponding software executed by hardware. The hardware or software includes one or more modules corresponding to the functions described above.

In a possible embodiment, the apparatus structurally includes a processor and a memory, wherein the memory is configured to store a program which supports the device in executing the above network accessing method for a voice device. The processor is configured to execute the program stored in the memory. The apparatus may further include a communication interface through which the apparatus communicates with other devices or communication networks.

In an eighth aspect, a computer-readable storage medium for storing computer software instructions used for a network accessing apparatus for a voice device is provided. The computer readable storage medium may include programs involved in executing of the network accessing method for a voice device described above.

One of the above technical solutions has the following advantages or beneficial effects: by broadcasting a voice including a name and a password of a network, network accessing configurations may be performed on multiple voice devices at a time, which may be used in a scenario of a batch sampling test of voice devices in a factory. In this way, work efficiency may be greatly improved. The network accessing process is simple and reliable, thereby improving user experience. In addition, no Bluetooth module needs to be added into a voice device, so that costs may be saved.

The above summary is provided only for illustration and is not intended to be limiting in any way. In addition to the illustrative aspects, embodiments, and features described above, further aspects, embodiments, and features of the present application will be readily understood from the following detailed description with reference to the accompanying drawings.

### BRIEF DESCRIPTION OF THE DRAWINGS

In the drawings, unless otherwise specified, identical or similar parts or elements are denoted by identical reference numerals throughout the drawings. The drawings are not necessarily drawn to scale. It should be understood these drawings merely illustrate some embodiments of the present application and should not be construed as limiting the scope of the present application.

FIG. 1 is a flowchart showing a network accessing method for a voice device according to an embodiment of the present application;

FIG. 2 is an interaction flowchart showing a network accessing method for a voice device according to an embodiment of the present application;

FIG. 3 is a flowchart showing an application of a network accessing method for a voice device to a user terminal according to an embodiment of the present application;

FIG. 4 is a flowchart showing an application of a network accessing method for a voice device to a server according to an embodiment of the present application;

FIG. 5 is a schematic structural diagram showing a network accessing apparatus for a voice device according to an embodiment of the present application;

FIG. 6 is a schematic structural diagram showing a network accessing apparatus for a voice device according to an embodiment of the present application;

FIG. 7 is a schematic structural diagram showing an application of a network accessing apparatus for a voice device to a user terminal according to an embodiment of the present application;

FIG. 8 is a schematic structural diagram showing an application of a network accessing apparatus for a voice device to a server according to an embodiment of the present application; and

FIG. 9 is a schematic structural diagram showing a network accessing apparatus for a voice device according to an embodiment of the present application.

### DETAILED DESCRIPTION OF THE EMBODIMENTS

Hereafter, only certain exemplary embodiments are briefly described. As can be appreciated by those skilled in the art, the described embodiments may be modified in different ways, without departing from the spirit or scope of the present application. Accordingly, the drawings and the description should be considered as illustrative in nature instead of being restrictive.

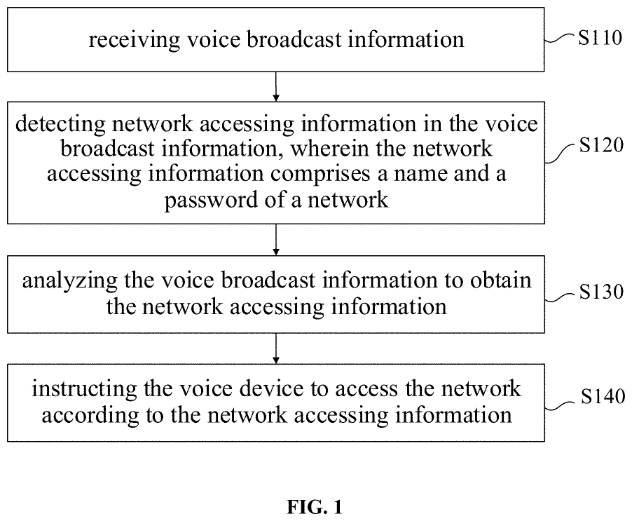

FIG. 1 is a flowchart showing a network accessing method for a voice device according to an embodiment of the present application. As shown in FIG. 1, the network accessing method for a voice device includes following steps.

In S110, voice broadcast information is received.

In S120, network accessing information in the voice broadcast information is detected, wherein the network accessing information includes a name and a password of a network.

In S130, the voice broadcast information is analyzed to obtain the network accessing information.

In S140, the voice device is instructed to access the network according to the network accessing information.

Only after a network accessing configuration is performed on a smart device, it may then be capable to access the internet. For example, in the case where a user purchases a smart speaker, or in a scenario where a batch sampling test is performed on smart voice devices in a factory, it is necessary to perform a network accessing configuration on a smart voice device first, such as performing a Wi-Fi network access configuration on a smart voice device. In embodiments of the present application, by broadcasting a voice including a name and a password of a network, network accessing configurations may be provided for at least one voice device at a time.

Specifically, in S110, the smart voice device may monitor a voice signal in an environment and receive voice broadcast information. In S120, the smart voice device may detect a name and a password of a network in the voice broadcast information. For example, the smart voice device may detect whether “network name” or a “SSID”, and a “security code” or a “password” are included in the voice broadcast information. If an above-mentioned keyword related to the network accessing information is detected, it may be determined that network accessing information is included in the voice broadcast information. The voice broadcast information may be generated according to a name and a password of a network provided by a user. In S130, if network accessing information is determined in the voice broadcast information, the voice broadcast information may be further analyzed by the smart voice device, so as to obtain the name and the password of the network. In S140, the smart voice device may be instructed to access the network according to the parsed name and password of the network. That is to say, according to the password in the network accessing information, the voice device may access the network having the name.

In the case where multiple voice devices monitor voice signals in an environment and receive voice broadcast information, the voice devices may perform network accessing configurations for themselves respectively, after parsing out the name and the password of the network from the voice broadcast information. Therefore, it is possible to implement network accessing configurations for multiple devices in batches.

In an implementation, before the receiving voice broadcast information, the method further includes following steps.

The voice device is activated.

The voice broadcast information is monitored.

In an example, a user purchases a smart speaker. The smart speaker may be activated and then a network accessing performance may be initiated. After the network accessing performance is initiated, the smart speaker may start to monitor voice signals in an environment and receive voice broadcast information. In another case, a user may issue a system reset instruction to the smart speaker. For example, the user may press a “reset” button on a panel of the smart speaker, and a network accessing performance may be initiated when the smart speaker performs a system reset.

In another example, a user may want to perform network accessing configurations for multiple smart voice devices in home at a time. The multiple smart voice devices in home may include a smart speaker, a smart voice air conditioner, a smart voice television or a smart voice light. The multiple smart voice devices in home may be activated, and network accessing performances may be initiated when the multiple smart voice devices are activated. After network accessing performances are initiated, the multiple smart voice devices may start to monitor voice signals in the environment and receive voice broadcast information. After receiving voice broadcast information respectively, each smart voice device may parse the voice broadcast information and perform a network accessing operation on itself. Therefore, in embodiments of the present application, network accessing configurations may be performed on multiple smart voice devices in home at a time. The network accessing process is simple and reliable, thereby improving user experience. In another example, a batch sampling test is performed on smart voice devices in a factory. In the process of the batch sampling test, multiple smart voice devices may be initiated. Then the network accessing performances are initiated when the multiple smart voice devices are activated. After network accessing performances are initiated, the multiple smart voice devices may start to monitor voice signals in the environment and receive voice broadcast information. After receiving voice broadcast information respectively, each smart voice device may parse the voice broadcast information and perform a network accessing operation on itself. Therefore, in embodiments of the present application, network accessing configurations may be performed on multiple smart voice devices at a time. In this way, work efficiency may be greatly improved. The network accessing process is simple and reliable, thereby improving user experience.

In an implementation, the method further includes following step.

An accessing result is broadcasted, wherein the accessing result includes a successful accessing and a failed accessing.

In this implementation, an accessing result of a network accessing operation is broadcasted, so that a user may continue to process subsequent operations according to the accessing result. For example, in the case where broadcasting information of an unsuccessful accessing is received, the name and the password of the network need to be input again by the user. Then, new voice broadcast information is generated and broadcasted according to the name and the password of the network provided by the user, so that the smart voice device may perform the network accessing operation in above steps from S110 to S140 again.

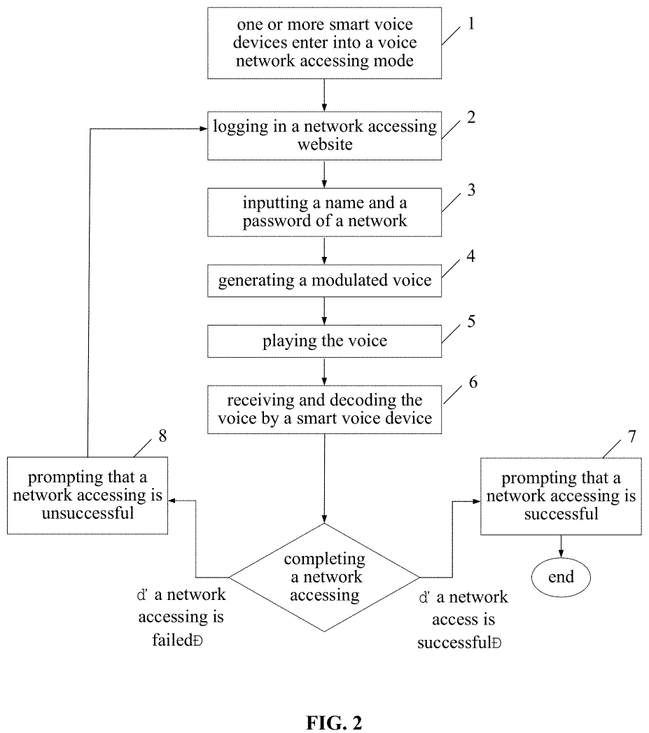

FIG. 2 is an interaction flowchart showing a network accessing method for a voice device according to an embodiment of the present application. A voice network accessing system may be set on a smart voice device. The voice network accessing system includes a voice demodulation and decoding module, a rule engine module, and a Text To Speech (TTS) broadcast module. The rules engine module is an assembly embedded in an application, which may separate an operational decision from application codes and write the operational decision by using a predefined semantic module. Then, data input may be received, operational rules may be interpreted, and operational decisions may be made according to the operational rules.

As shown in FIG. 2, a schematic network accessing process is illustrated as follows.

1) One or more smart voice devices enter into a voice network accessing mode. The initiation event for entering into the voice network accessing mode may be an event such as a first activation of the smart voice device, a system reset.

2) A user logs in a network accessing internet website through a browser of a mobile phone or a laptop.

3) A name and a password of a network are input on a specific webpage of the above website.

4) A modulated voice file is generated by the website based on the name and the password of the network.

5) The above voice file is played on the user's mobile phone or laptop.

6) One or more smart voice devices receive the voice file, demodulate and decode the voice file, to obtain a corresponding name and password of the network, so as to perform a network accessing configuration.

7) In the case where the configuration is successful, the rule engine module prompts the user through the TTS module that the network accessing is successful, and then the process ends.

8) In the case where the configuration is unsuccessful, the rule engine module prompts the user through the TTS module that the network accessing is unsuccessful, and then the process turns back to the above step 3). The above steps are performed cyclically until the network accessing of the smart voice device completes.

Various fault tolerance processes may be included in the above process. For example, a user is required to input a name and a password of a network again, after he has input them once. In the case where the two inputs are the same, it may then be confirmed that the input from the user is correct.

In embodiments of the present application, by using the voice broadcast mode, a user may access a network through a smart voice device without downloading a companion APP, thereby improving user experience.

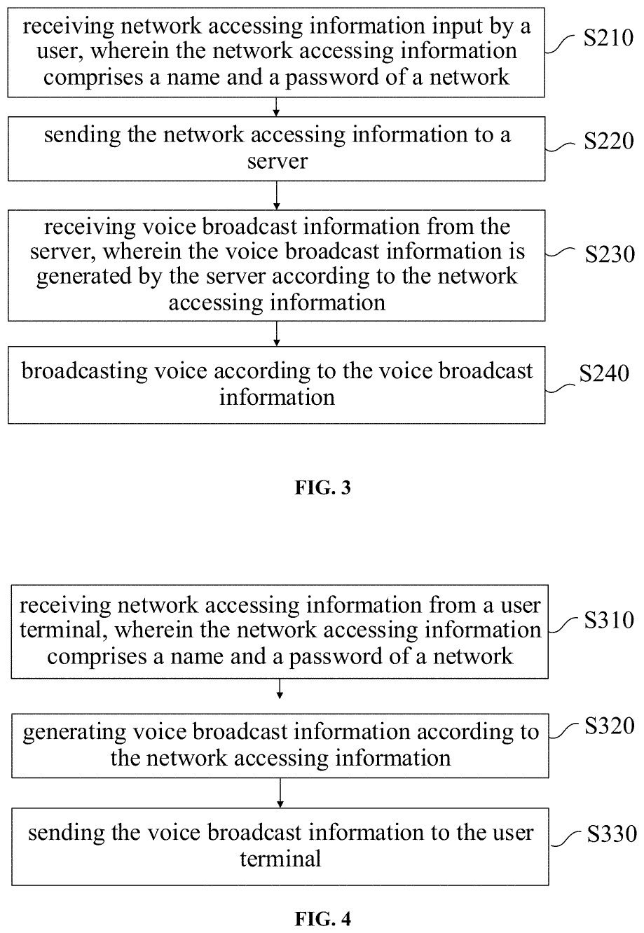

FIG. 3 is a flowchart showing an application of a network accessing method for a voice device to a user terminal according to an embodiment of the present application. As shown in FIG. 3, the network accessing method for a voice device includes following steps.

In S210: network accessing information input by a user is received, wherein the network accessing information includes a name and a password of a network.

In S220, the network accessing information is sent to a server.

In S230, voice broadcast information is received from the server, wherein the voice broadcast information is generated by the server according to the network accessing information.

In S240, voice is broadcasted according to the voice broadcast information.

As mentioned above, the voice broadcast information may be generated according to a name and a password of a network provided by a user. The voice broadcast information is generated and broadcasted according to the name and the password of the network provided by the user, so that the smart voice device may perform the network accessing operation in above steps from S110 to S140. A user may provide the name and the password of the network used for the network accessing operation through a user's terminal, such as a mobile phone or a laptop.

Specifically, in S210, the user logs in an internet website which is pre-created for a network accessing of a smart voice device and inputs the name and the password of a network used for the network accessing on a specific webpage of the website. Then, the user's terminal receives the name and the password of the network input by the user through a specific page of the website.

In S220, the user's terminal sends the name and the password of the network input by the user to a server, so that the server may generate voice broadcast information according to the name and the password of the network. In S230, the user's terminal receives voice broadcast information from the server, wherein the voice broadcast information includes the name and the password of the network. In S240, a voice is broadcasted by the user's terminal, so that the smart voice device may perform the network accessing operation in the above steps from S110 to S140 after receiving the voice broadcast information.

FIG. 4 is a flowchart showing an application of a network accessing method for a voice device to a server according to an embodiment of the present application. As shown in FIG. 4, the network accessing method for a voice device includes following steps.

In S310, network accessing information is received from a user terminal, wherein the network accessing information includes a name and a password of a network.

In S320, voice broadcast information is generated according to the network accessing information.

In S330, the voice broadcast information is sent to the user terminal.

As mentioned above, voice broadcast information may be generated and broadcasted according to a name and a password of a network provided by a user, so that a smart voice device may perform a network accessing operation in above steps from S110 to S140. Specifically, in S310, a server receives a name and a password of a network from a user's terminal. In S320, the server generates voice broadcast information according to the name and the password of the network. In S330, the server sends the voice broadcast information to the user terminal, to broadcast the voice broadcast information at the user terminal. The smart voice device monitors a voice signal in an environment and may perform the network accessing operation in the above steps from S110 to S140, after receiving the voice broadcast information including the name and the password of the network.

In an implementation, in S320, the generating voice broadcast information according to the network accessing information may include generating speech broadcast information according to the network accessing information. After the user terminal receives the voice broadcast information generated by the server, the network accessing information in a speech form may be directly broadcasted. For example, the content played by a user terminal is as follows: “network name: WIFIXX; password: 1234xxxx.” After receiving the above speech broadcast information including the name and the password of the network, the smart voice device may perform a network accessing operation according to the received name and password of the network.

In another implementation, in S320, the generating voice broadcast information according to the network accessing information may include modulating the network accessing information into an original voice file at a specific frequency and generating voice broadcast information carrying the network accessing information. The content of the original voice file may include a voice such as a piece of music, a speech, a recorded sound. After receiving the voice broadcast information carrying the network accessing information, a user terminal may broadcast the voice broadcast information. Then, a smart voice device receives the voice broadcast information carrying the network accessing information, performs a voice decoding on the voice broadcast information, and parses out the network accessing information and the original voice file from the voice broadcast information. The smart voice device performs a network accessing operation according to the parsed name and the parsed password of the network and broadcasts the parsed original voice file. In this implementation, the name and the password of a network are not directly broadcasted, therefore, a password leakage may be prevented, thereby better protecting the information security.

The above technical solution has the following advantages or beneficial effects: by broadcasting a voice including a name and a password of a network, network accessing configurations may be performed on multiple voice devices at a time, which may be used in a scenario of a batch sampling test of voice devices in a factory. In this way, work efficiency may be greatly improved. The network accessing process is simple and reliable, thereby improving user experience. In addition, no Bluetooth module needs to be added into a voice device, so that costs may be saved.

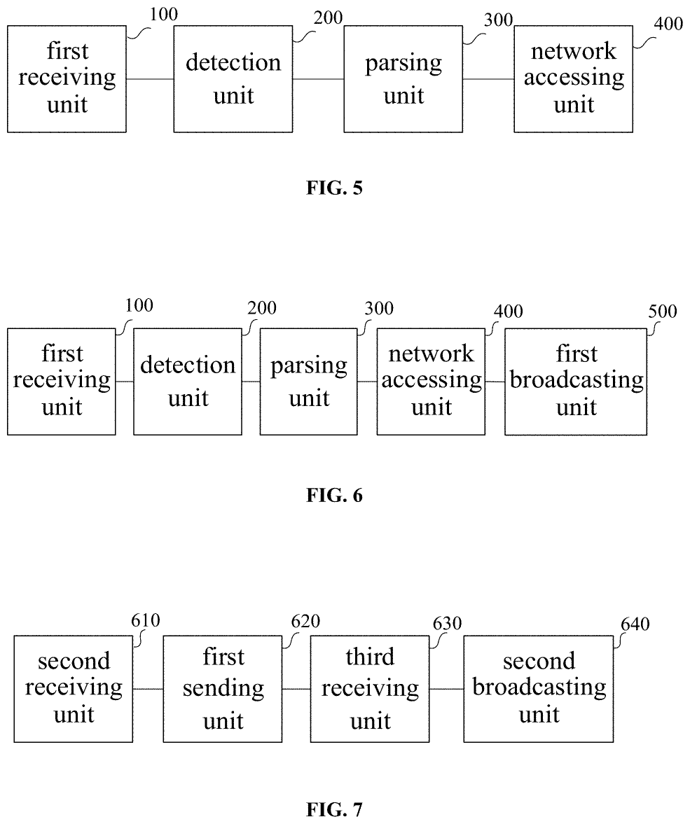

FIG. 5 is a schematic structural diagram showing a network accessing apparatus for a voice device according to an embodiment of the present application. As shown in FIG. 5, the network accessing apparatus for a voice device according to an embodiment of the present application includes:

a first receiving unit 100, configured to receive voice broadcast information;

a detection unit 200, configured to detect network accessing information in the voice broadcast information, wherein the network accessing information includes a name and a password of a network;

a parsing unit 300, configured to analyze the voice broadcast information to obtain the network accessing information; and

a network accessing unit 400, configured to instruct the voice device to access the network according to the network accessing information.

In an implementation, the first receiving unit 100 is configured to:

activate the voice device; and

monitor the voice broadcast information.

FIG. 6 is a schematic structural diagram showing a network accessing apparatus for a voice device according to an embodiment of the present application. As shown in FIG. 6, in an implementation, the apparatus further includes a first broadcasting unit 500, which is configured to:

broadcast an accessing result, wherein the accessing result includes a successful accessing and a failed accessing.

FIG. 7 is a schematic structural diagram showing an application of a network accessing apparatus for a voice device to a user terminal according to an embodiment of the present application. As shown in FIG. 7, the network accessing apparatus for a voice device includes:

a second receiving unit 610, configured to receive network accessing information input by a user, wherein the network accessing information includes a name and a password of a network;

a first sending unit 620, configured to send the network accessing information to a server;

a third receiving unit 630, configured to receive voice broadcast information from the server, wherein the voice broadcast information is generated by the server according to the network accessing information; and

a second broadcasting unit 640, configured to broadcast voice according to the voice broadcast information.

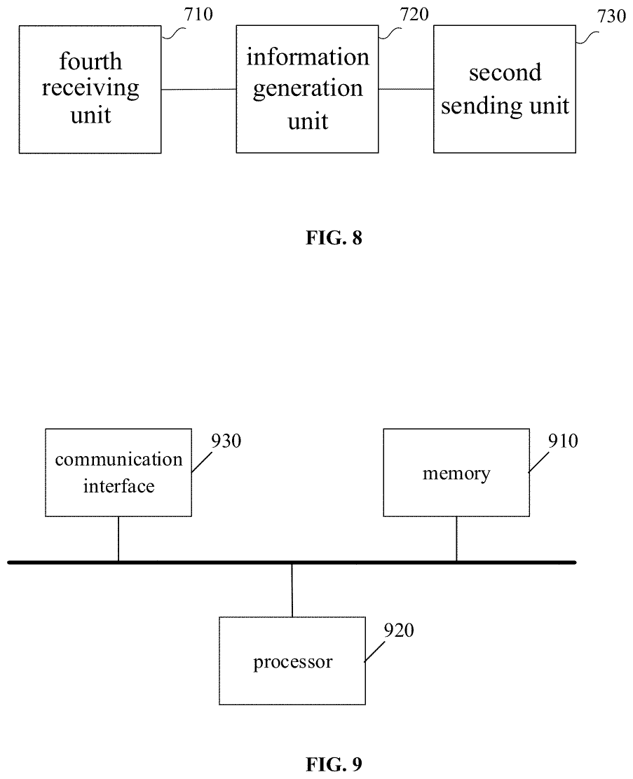

FIG. 8 is a schematic structural diagram showing an application of a network accessing apparatus for a voice device to a server according to an embodiment of the present application. As shown in FIG. 8, the network accessing apparatus for a voice device includes:

a fourth receiving unit 710, configured to receive network accessing information from a user terminal, wherein the network accessing information includes a name and a password of a network;

an information generation unit 720, configured to generate voice broadcast information according to the network accessing information; and

a second sending unit 730, configured to send the voice broadcast information to the user terminal.

In this embodiment, functions of modules in the apparatus refer to the corresponding description of the method mentioned above and thus a detailed description thereof is omitted herein.

FIG. 9 is a schematic structural diagram showing a network accessing apparatus for a voice device according to an embodiment of the present application. As shown in FIG. 9, the apparatus includes a memory 910 and a processor 920, wherein a computer program that can run on the processor 920 is stored in the memory 910. The processor 920 executes the computer program to implement the network accessing method for a voice device according to foregoing embodiments. The number of either the memory 910 or the processor 920 may be one or more.

The apparatus further includes:

a communication interface 930 configured to communicate with an external device and exchange data.

The memory 910 may include a high-speed RAM memory and may also include a non-volatile memory, such as at least one magnetic disk memory.

If the memory 910, the processor 920, and the communication interface 930 are implemented independently, the memory 910, the processor 920, and the communication interface 930 may be connected to each other via a bus to realize mutual communication. The bus may be an Industry Standard Architecture (ISA) bus, a Peripheral Component Interconnected (PCI) bus, an Extended Industry Standard Architecture (EISA) bus, or the like. The bus may be categorized into an address bus, a data bus, a control bus, and the like. For ease of illustration, only one bold line is shown in FIG. 9 to represent the bus, but it does not mean that there is only one bus or one type of bus.

Optionally, in a specific implementation, if the memory 910, the processor 920, and the communication interface 930 are integrated on one chip, the memory 910, the processor 920, and the communication interface 930 may implement mutual communication through an internal interface.

In an implementation, the network accessing apparatus for a voice device includes a smart speaker.

According to an embodiment of the present application, a computer-readable storage medium for storing a computer program is provided. The computer program, when executed by a processor, causes the processor to implement any one of the methods described above.

In the description of the specification, the description of the terms “one embodiment,” “some embodiments,” “an example,” “a specific example,” or “some examples” and the like means the specific features, structures, materials, or characteristics described in connection with the embodiment or example are included in at least one embodiment or example of the present application. Furthermore, the specific features, structures, materials, or characteristics described may be combined in any suitable manner in any one or more of the embodiments or examples. In addition, different embodiments or examples described in this specification and features of different embodiments or examples may be incorporated and combined by those skilled in the art without mutual contradiction.

In addition, the terms “first” and “second” are used for descriptive purposes only and are not to be construed as indicating or implying relative importance or implicitly indicating the number of indicated technical features. Thus, features defining “first” and “second” may explicitly or implicitly include at least one of the features. In the description of the present application, “a plurality of” means two or more, unless expressly limited otherwise.

Any process or method descriptions described in flowcharts or otherwise herein may be understood as representing modules, segments or portions of code that include one or more executable instructions for implementing the steps of a particular logic function or process. The scope of the preferred embodiments of the present application includes additional implementations where the functions may not be performed in the order shown or discussed, including according to the functions involved, in substantially simultaneous or in reverse order, which should be understood by those skilled in the art to which the embodiment of the present application belongs.

Logic and/or steps, which are represented in the flowcharts or otherwise described herein, for example, may be thought of as a sequencing listing of executable instructions for implementing logic functions, which may be embodied in any computer-readable medium, for use by or in connection with an instruction execution system, device, or apparatus (such as a computer-based system, a processor-included system, or other system that fetch instructions from an instruction execution system, device, or apparatus and execute the instructions). For the purposes of this specification, a “computer-readable medium” may be any device that may contain, store, communicate, propagate, or transport the program for use by or in connection with the instruction execution system, device, or apparatus. The computer readable medium of the embodiments of the present application may be a computer readable signal medium or a computer readable storage medium or any combination of the above. More specific examples (not a non-exhaustive list) of the computer-readable media include the following: electrical connections (electronic devices) having one or more wires, a portable computer disk cartridge (magnetic device), random access memory (RAM), read only memory (ROM), erasable programmable read only memory (EPROM or flash memory), optical fiber devices, and portable read only memory (CDROM). In addition, the computer-readable medium may even be paper or other suitable medium upon which the program may be printed, as it may be read, for example, by optical scanning of the paper or other medium, followed by editing, interpretation or, where appropriate, process otherwise to electronically obtain the program, which is then stored in a computer memory.

It should be understood various portions of the present application may be implemented by hardware, software, firmware, or a combination thereof. In the above embodiments, multiple steps or methods may be implemented in software or firmware stored in memory and executed by a suitable instruction execution system. For example, if implemented in hardware, as in another embodiment, they may be implemented using any one or a combination of the following techniques well known in the art: discrete logic circuits having a logic gate circuit for implementing logic functions on data signals, application specific integrated circuits with suitable combinational logic gate circuits, programmable gate arrays (PGA), field programmable gate arrays (FPGAs), and the like.

Those skilled in the art may understand that all or some of the steps carried in the methods in the foregoing embodiments may be implemented by a program instructing relevant hardware. The program may be stored in a computer-readable storage medium, and when executed, one of the steps of the method embodiment or a combination thereof is included.

In addition, each of the functional units in the embodiments of the present application may be integrated in one processing module, or each of the units may exist alone physically, or two or more units may be integrated in one module. The above-mentioned integrated module may be implemented in the form of hardware or in the form of software functional module. When the integrated module is implemented in the form of a software functional module and is sold or used as an independent product, the integrated module may also be stored in a computer-readable storage medium. The storage medium may be a read only memory, a magnetic disk, an optical disk, or the like.

The foregoing descriptions are merely specific embodiments of the present application, but not intended to limit the protection scope of the present application. Those skilled in the art may easily conceive of various changes or modifications within the technical scope disclosed herein, all these should be covered within the protection scope of the present application. Therefore, the protection scope of the present application should be subject to the protection scope of the claims.

What is claimed is:

1. A network accessing method for a voice device, comprising:
receiving voice broadcast information;
detecting network accessing information in the voice broadcast information, wherein the network accessing information comprises a name and a password of a network;
analyzing the voice broadcast information to obtain the network accessing information; and
instructing the voice device to access the network according to the network accessing information.

2. The network accessing method according to claim 1, wherein before the receiving voice broadcast information, the method further comprises:
activating the voice device; and
monitoring the voice broadcast information.

3. The network accessing method according to claim 1, further comprising:
broadcasting an accessing result, wherein the accessing result comprises a successful accessing and a failed accessing.

4. A network accessing method for a voice device, comprising:
receiving network accessing information input by a user, wherein the network accessing information comprises a name and a password of a network;
sending the network accessing information to a server;
receiving voice broadcast information from the server, wherein the voice broadcast information is generated by the server according to the network accessing information; and
broadcasting a voice according to the voice broadcast information.

5. A network accessing method for a voice device, comprising:
receiving network accessing information from a user terminal, wherein the network accessing information comprises a name and a password of a network;
generating voice broadcast information according to the network accessing information; and
sending the voice broadcast information to the user terminal.

6. A network accessing apparatus for a voice device, comprising:
one or more processors; and
a memory for storing one or more programs, wherein
the one or more programs are executed by the one or more processors to enable the one or more processors to:
receive voice broadcast information;
detect network accessing information in the voice broadcast information, wherein the network accessing information comprises a name and a password of a network;
analyze the voice broadcast information to obtain the network accessing information; and
instruct the voice device to access the network according to the network accessing information.

7. The network accessing apparatus for a voice device according to claim 6, wherein the one or more programs are executed by the one or more processors to enable the one or more processors to:
activate the voice device; and
monitor the voice broadcast information.

8. The network accessing apparatus for a voice device according to claim 6, wherein the one or more programs are executed by the one or more processors to enable the one or more processors to:
broadcast an accessing result, wherein the accessing result comprises a successful accessing and a failed accessing.

9. A network accessing apparatus for a voice device, comprising:
one or more processors; and
a memory for storing one or more programs, wherein
the one or more programs are executed by the one or more processors to enable the one or more processors to:
receive network accessing information input by a user, wherein the network accessing information comprises a name and a password of a network;
send the network accessing information to a server;
receive voice broadcast information from the server, wherein the voice broadcast information is generated by the server according to the network accessing information; and
broadcast voice according to the voice broadcast information.

10. A network accessing apparatus for a voice device, comprising:
one or more processors; and
a memory for storing one or more programs, wherein
the one or more programs are executed by the one or more processors to enable the one or more processors to:
receive network accessing information from a user terminal, wherein the network accessing information comprises a name and a password of a network;
generate voice broadcast information according to the network accessing information; and
send the voice broadcast information to the user terminal.

11. A non-transitory computer-readable storage medium, in which a computer program is stored, wherein the computer program, when executed by a processor, causes the processor to:
receive voice broadcast information;
detect network accessing information in the voice broadcast information, wherein the network accessing information comprises a name and a password of a network;
analyze the voice broadcast information to obtain the network accessing information; and
instruct the voice device to access the network according to the network accessing information.

12. The non-transitory computer-readable storage medium according to claim 11, wherein the computer program, when executed by a processor, causes the processor to:
activating the voice device; and
monitoring the voice broadcast information.

13. The non-transitory computer-readable storage medium according to claim 11, wherein the computer program, when executed by a processor, causes the processor to:
broadcasting an accessing result, wherein the accessing result comprises a successful accessing and a failed accessing.

14. The non-transitory computer-readable storage medium according to claim 11, wherein the computer program, when executed by a processor, causes the processor to:
receive network accessing information input by a user, wherein the network accessing information comprises a name and a password of a network;
send the network accessing information to a server;
receive voice broadcast information from the server, wherein the voice broadcast information is generated by the server according to the network accessing information; and
broadcast a voice according to the voice broadcast information.

15. The non-transitory computer-readable storage medium according to claim 11, wherein the computer program, when executed by a processor, causes the processor to:
receive network accessing information from a user terminal, wherein the network accessing information comprises a name and a password of a network;
generate voice broadcast information according to the network accessing information; and
send the voice broadcast information to the user terminal.
